(19) United States
(12) Patent Application Publication
(10) Pub. No.: US 2026/0289658 A1
(43) Pub. Date: Sep. 24, 2026

(54) UTILIZING A VISION-LANGUAGE MODEL FOR MOBILE DEPOSIT DECISIONING

(71) Applicant: Chime Financial, Inc., San Francisco, CA (US)

(72) Inventors: Akshay Jain, Boise, ID (US); Dennis Yang, San Francisco, CA (US); Adrian Cervantes, Walnut Creek, CA (US); Avik Chakravarty, San Francisco, CA (US); Alex Benoit, New York, NY (US); Anton Laptiev, Vancouver (CA); Aran January, Los Angeles, CA (US); Gagandeep Singh, Dallas, TX (US); Jiby Babu, San Francisco, CA (US); Shrey Verma, Toronto (CA); Samarjith Jawaharlal Sathyanarayan, Buffalo Grove, IL (US)

(21) Appl. No.: 19/094,344

(22) Filed: Mar. 28, 2025

Related U.S. Application Data
(60) Provisional application No. 63/774,687, filed on Mar. 19, 2025.

(51) Int. Cl. G06Q 40/02; G06Q 20/04; G06Q 20/40; G06V 10/44; G06V 10/75; G06V 10/94; G06V 30/18; G06V 30/19; G06V 30/22; G06V 30/42

(52) U.S. Cl. CPC G06Q 40/02; G06Q 20/042; G06Q 20/4016; G06V 10/44; G06V 10/751; G06V 10/95; G06V 30/18133; G06V 30/19013; G06V 30/42; G06V 30/22

(57) ABSTRACT

The present disclosure relates to systems, non-transitory computer-readable media, and methods for utilizes a vision-language model to determine whether to accept or reject mobile checking deposits. In particular, the disclosed systems generate, in response to a deposit request comprising a check image from a client device, a machine learning model prompt comprising the check image and instructions for extracting features of the check image. Additionally, the disclosed systems extract, utilizing a vision-language model, the features of the check image indicated in the instructions of the machine learning model prompt. Further, the disclosed systems determine, utilizing a deposit decision model comprising a set of check deposit rules, a transaction decision indicating to accept or reject the deposit request according to the extracted features of the check image. Moreover, the disclosed systems cause a transaction system to accept or reject the deposit request based on the transaction decision.

### CROSS-REFERENCE TO RELATED APPLICATIONS

This application claims priority to and the benefit of U.S. Provisional Patent Application No. 63/774,687, filed on Mar. 19, 2025, which is incorporated herein by reference in its entirety.

### BRIEF DESCRIPTION OF THE DRAWINGS

The detailed description provides one or more embodiments with additional specificity and detail through the use of the accompanying drawings, as briefly described below.

FIG. 1 illustrates an overview diagram of the visual deposit system utilizing a vision-language model to accept or reject mobile check deposit requests in accordance with one or more embodiments.

FIG. 2 illustrates a diagram of the visual deposit system generating a machine learning model prompt in accordance with one or more embodiments.

FIG. 3 illustrates a diagram of the visual deposit system utilizing a vision-language model to extract check information features from a check image in accordance with one or more embodiments.

FIG. 4 illustrates a diagram of the visual deposit system utilizing a vision-language model to extract physical features of a check image in accordance with one or more embodiments.

FIG. 5 illustrates a diagram of the visual deposit system utilizing a deposit decision model to determine a transaction decision based on check image features in accordance with one or more embodiments.

FIG. 6 illustrates a diagram of the visual deposit system providing extracted check image features for manual review in accordance with one or more embodiments.

FIG. 7 illustrates a diagram of the visual deposit system training a mobile check deposit model to determine a transaction decision based on check image features in accordance with one or more embodiments.

FIG. 8 illustrates a diagram of the visual deposit system implementing a mobile check deposit model to determine a transaction decision based on check image features in accordance with one or more embodiments.

FIG. 9 illustrates a diagram of the visual deposit system utilizing a vision-language model to determine a transaction decision based on check image features of a check image in accordance with one or more embodiments.

FIG. 10 illustrates a diagram of an environment in which a visual deposit system can operate in accordance with one or more embodiments.

FIG. 11 illustrates a flowchart of an example series of acts for utilizing a vision-language model to extract check image features for determining whether to accept or reject a mobile check deposit request in accordance with one or more embodiments.

FIG. 12 illustrates a block diagram of an example computing device for implementing one or more embodiments of the present disclosure.

FIG. 13 illustrates an example environment for an inter-network facilitation system in accordance with one or more embodiments.

### DETAILED DESCRIPTION

This disclosure describes one or more embodiments of a visual deposit system that utilizes a vision-language model to extract check image features for determining whether to accept or reject mobile checking deposits. Specifically, the visual deposit system utilizes image processing to extract check image features from a check image of a deposit request. Further, the visual deposit system determines a transaction decision indicating whether to accept or reject the deposit request by identifying fraud indicators in the check image based on the extracted check image features. More specifically, the visual deposit system can use a deposit decision model to leverage a number of rules and heuristics to detect the fraud indicators based on the extracted check image features. Moreover, in some embodiments, the visual deposit system trains and implements a mobile check deposit model to determine the transaction decision indicating whether to accept or reject the deposit request based on the check image features. Furthermore, in some implementations, the visual deposit system utilizes a vision-language model to determine the transaction decision based on the check image features.

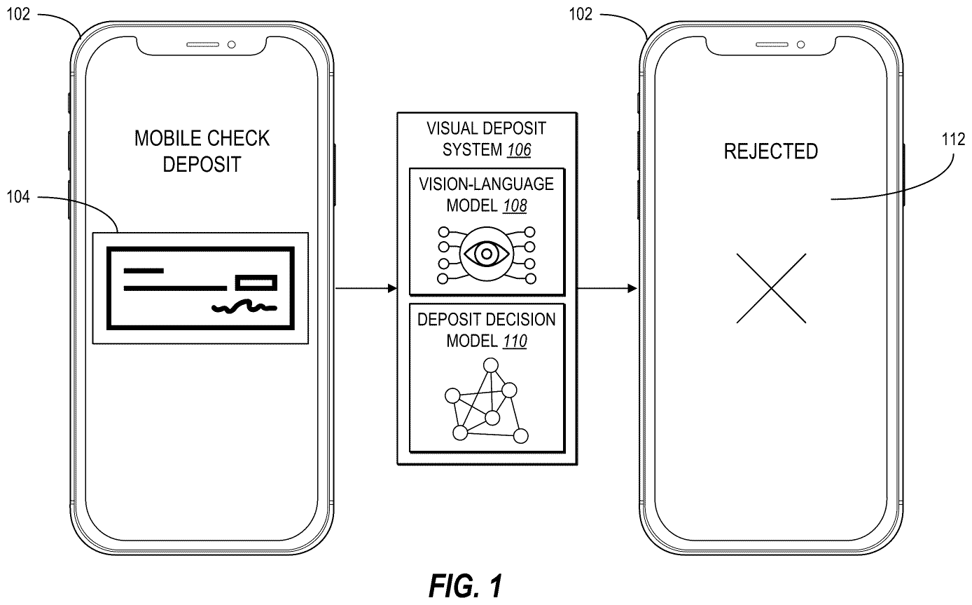

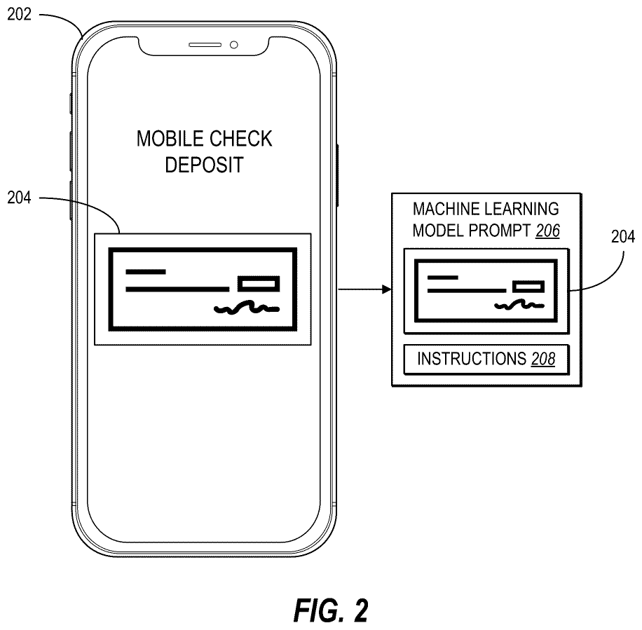

FIG. 1 illustrates an overview diagram of a visual deposit system 106 utilizing a vision-language model 108 to accept or reject mobile check deposit requests in accordance with one or more embodiments. As illustrated in FIG. 1, in one or more embodiments, the visual deposit system 106 receives a check image 104 of a deposit request via a client device 102. For example, the check image 104 can include a digital image of a check captured utilizing the client device 102 in connection with a request to deposit funds from the check into an account associated with the client device (or with a user of the client device). Additionally, in one or more implementations, the visual deposit system 106 generates a machine learning model prompt including the check image 104 for use with the vision-language model 108. Additional detail regarding generating the machine learning model prompt is provided with respect to FIG. 2.

In some embodiments, the vision-language model 108 includes a machine learning model designed to process and understand both visual inputs and text inputs. In particular, the vision-language model 108 combines computer vison or techniques for image analysis with natural language processing to interpret and generate text. Specifically, the vision-language model 108 includes one or more of a Large Language and Vision Assistant (LLaVa) model, a Contrastive Language-Image Pretraining (CLIP) model, or other multimodel models for handling both text and image inputs. Alternatively, in one or more embodiments, the visual deposit system 106 utilizes a plurality of models or processes to process the image check 104, such as optical character recognition in combination with one or more image processing models (e.g., an encoder-decoder neural network) to enhance the optical character recognition capabilities.

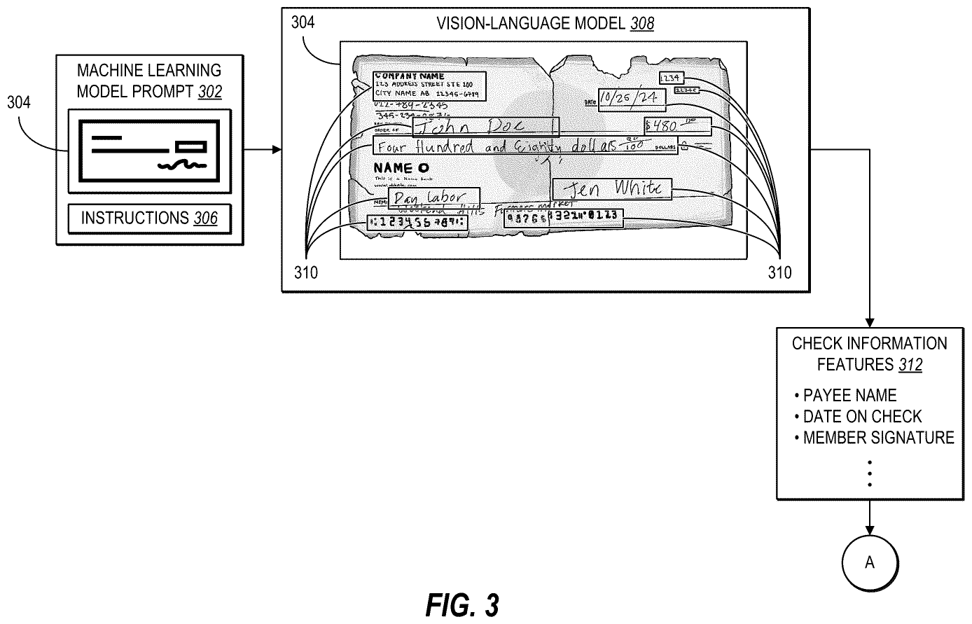

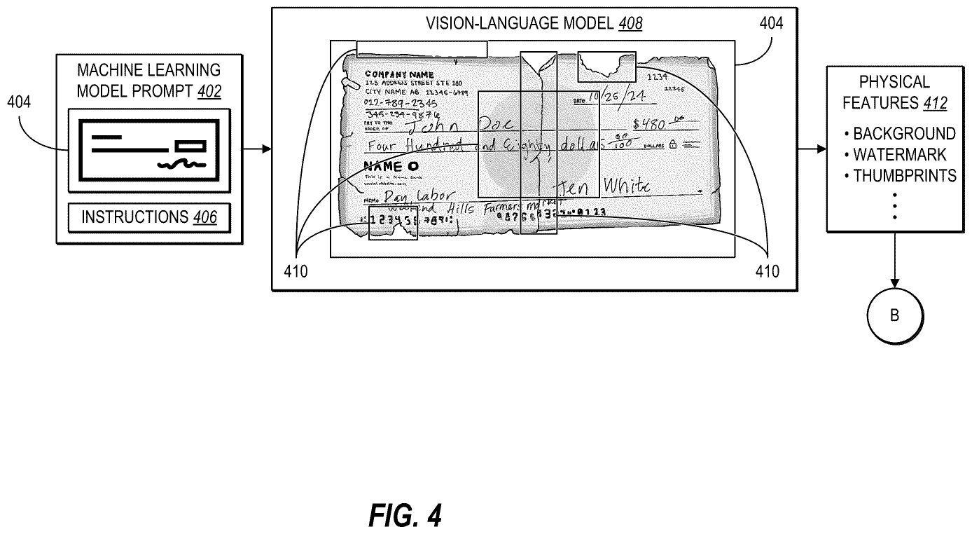

Further, in some implementations, the visual deposit system 106 utilizes the vision-language model 108 to extract check image features from the check image 104. In particular, the visual deposit system 106 can utilize the vision-language model 108 to extract check information features of the check image including alphanumeric information (e.g., a check date, a memo line, a payee name, etc.) recorded on the check of the check image. Moreover, the visual deposit system 106 can utilize the vision-language model 108 to extract physical features of the check image including check condition information or other check image information (e.g., alterations to the check, background objects included in the check image in addition to the check, scratches or tears on the check, etc.). Additional detail regarding utilizing the vision-language model 108 to extract the check image features is provided with respect to FIGS. 3 and 4.

As further illustrated in FIG. 1, in one or more embodiments, the visual deposit system 106 includes a deposit decision model 110. In one or more implementations, the deposit decision model 110 includes a machine learning model trained and/or tuned based on inputs to approximate unknown functions. For example, deposit decision model 110 includes a computer algorithm with branches, weights, or parameters that change based on training data to improve for a particular task. Thus, the deposit decision model 110 utilizes one or more learning techniques (e.g., supervised or unsupervised learning) to improve in accuracy and/or effectiveness. In one or more embodiments, the deposit decision model 110 includes a binary classification model. In additional embodiments, the deposit decision model 110 includes computer code to execute instructions for applying various rules and/or heuristics to extracted information in connection with making a decision regarding a deposit request.

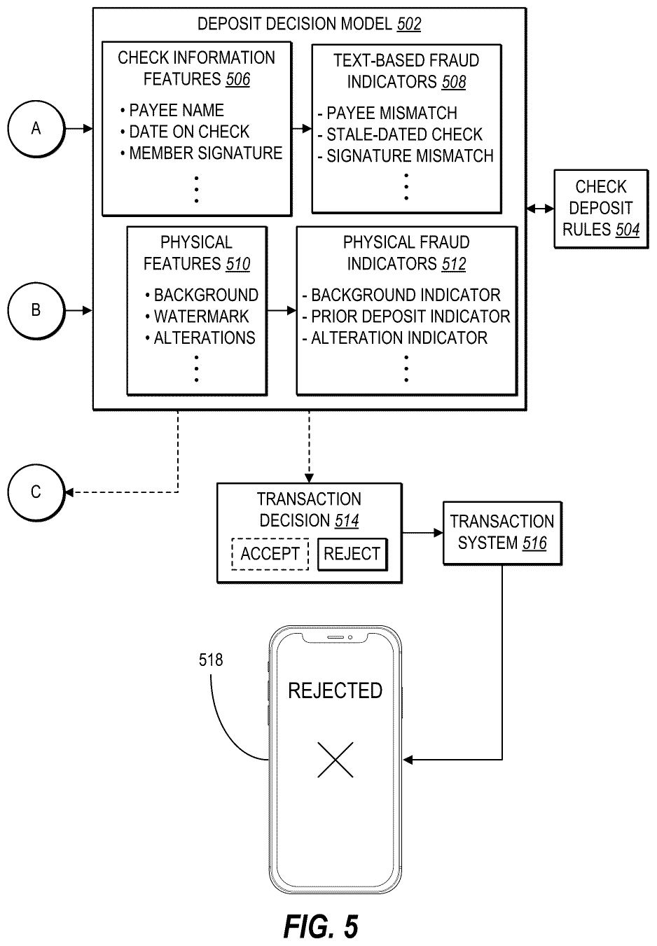

In some embodiments, the visual deposit system 106 utilizes the deposit decision model 110 to determine a transaction decision. For example, the visual deposit system 106 utilizes the deposit decision model 110 to determine a transaction decision indicating whether to automatically accept or reject the deposit request based on the extracted check image features. To illustrate, the deposit decision model 110 determines whether to accept or reject the deposit request by identifying fraud indicators in the check image 104 utilizing the extracted check image features. Additional detail regarding determining the transaction decision is provided with respect to FIG. 5.

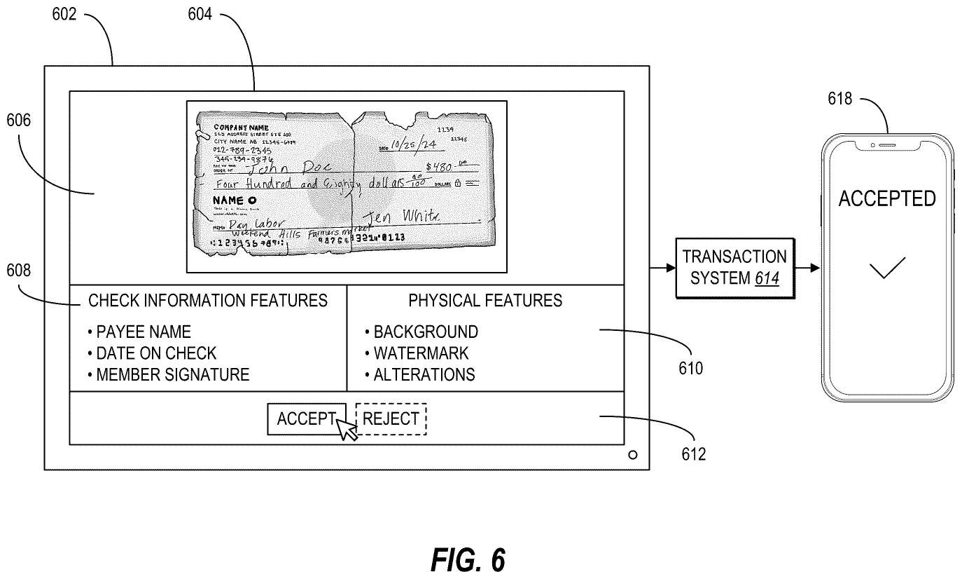

In some cases, the visual deposit system 106 determines that the deposit request cannot be automatically accepted or rejected. In these or other embodiments, the visual deposit system 106 provides the extracted check image features and the check image 104 to a user device for manual review as discussed further with respect to FIG. 6.

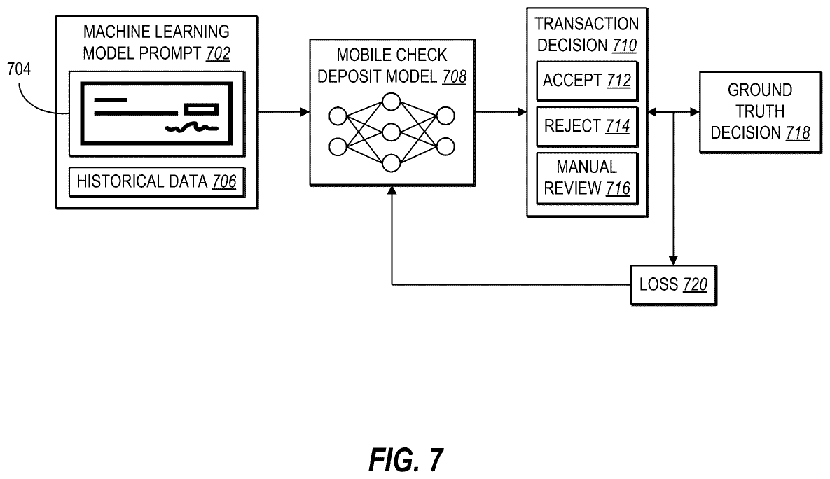

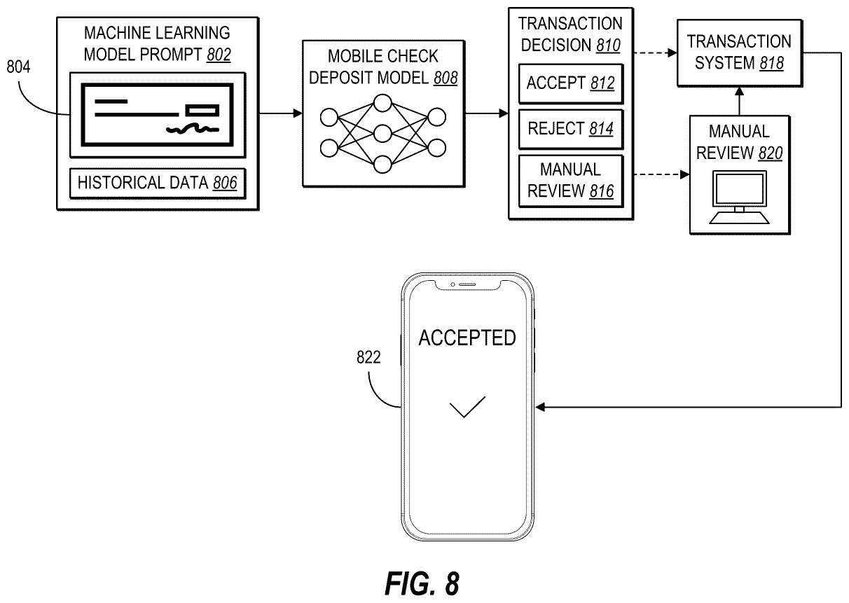

In some implementations, the visual deposit system 106 utilizes a mobile check deposit model to determine the transaction decision. Specifically, the visual deposit system 106 trains the mobile check deposit model to determine the transaction decision using a check image dataset. For instance, the visual deposit system 106 trains and implements the mobile check deposit model to determine the transaction decision by identifying the check image features. To illustrate, the visual deposit system 106 utilizes the trained mobile check deposit model to identify the check image features and any indicators of fraud therein. Additional detail regarding training and implementing the mobile check deposit model to determine the transaction decision is provided with respect to FIGS. 7 and 8, respectively.

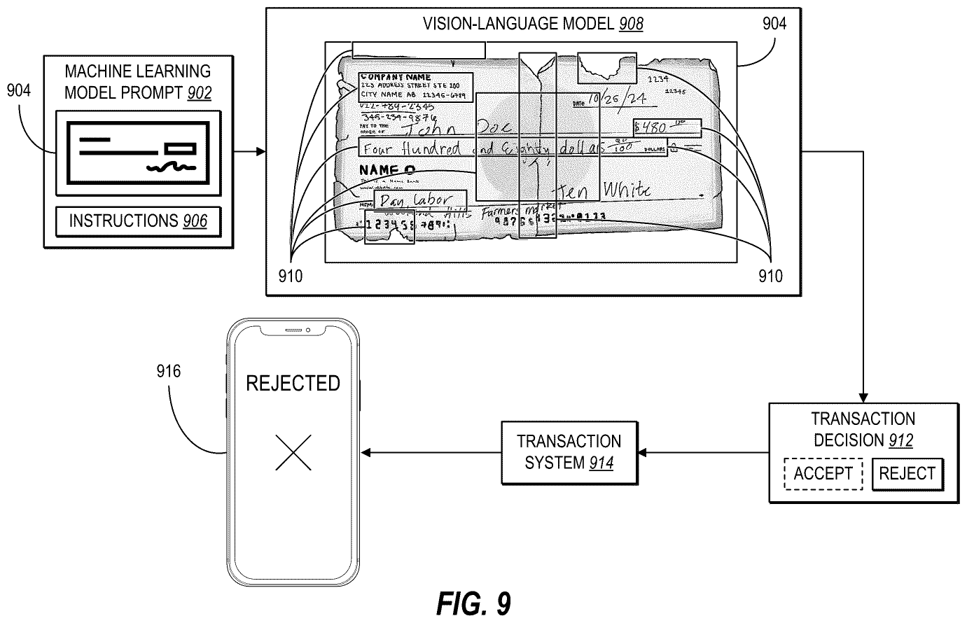

In one or more embodiments, the visual deposit system 106 utilizes the vision-language model 108 to determine the transaction decision. In particular, the visual deposit system 106 utilizes the check image 104 and instructions for identifying check image features and fraud indicators with the vision-language model 108 to determine the transaction decision (e.g., without any additional models or processes). Thus, in one or more embodiments, the visual deposit system 106 utilizes the vision-language model 108 to receive the check image 104 (and in some cases additional transaction information) and generate the transaction decision. Additional detail regarding utilizing the vision-language model 108 to determine the transaction decision is provided with respect to FIG. 9.

As additionally shown in FIG. 1, in one or more implementations, the visual deposit system 106 automatically causes a transaction system to accept or reject the deposit request in accordance with the transaction decision. Furthermore, in some embodiments, the visual deposit system 106 provides (e.g., directly or indirectly via the transaction system) a notification 112 of the transaction decision to the client device 102.

Although conventional systems can automate certain financial transactions such as mobile check deposits, such systems have a number of problems in relation to accuracy, flexibility of operation, and technological implementation. For instance, conventional systems inaccurately determine that some transactions are not fraudulent and process the fraudulent transactions resulting in financial losses. Specifically, to determine whether a transaction is fraudulent, conventional systems often utilize information such as historical behavior and transactions of a client account requesting the deposit as well as user input information such as a deposit amount. While conventional systems are capable of using this information to identify a percentage of fraudulent transactions, conventional systems still process a significant percentage of fraudulent transactions. Further, although some conventional systems utilize optical character recognition (OCR) methods to extract information from a check for use in identifying fraud, such methods are limited to extracting text and often do so inaccurately resulting in relatively low accuracy fraud detection.

In addition to their inaccuracies, conventional systems demonstrate operational inflexibility by utilizing a restricted dataset for fraud detection. For instance, conventional systems do not have the flexibility to utilize multiple different types of data for detecting fraudulent check deposit requests (i.e., the conventional systems are single modal systems). In particular, as mentioned above, conventional systems utilize only information such as historical behavior and transactions of a client account requesting the deposit and the deposit amount as included by the requestor in a field of the application. This inflexible approach results in a failure to identify fraudulent deposit requests as mentioned above due to missing certain critical indicators in other types of data.

Furthermore, conventional systems face technological limitations when detecting fraud in addition to their inaccuracies and inefficiencies. More particularly, conventional systems face problems resulting from the technological automation of processing check deposit requests. For example, prior to automated check deposit processing methods (e.g., mobile check deposit) checks were deposited manually (e.g., by a bank teller). This method included designed and natural fraud detection methods such as the use of magnetic ink, a teller's ability to directly observe the physical state of a check to detect fraudulent alterations, etc. By automating the process of check deposit transactions, conventional systems created technological problems by removing the designed and natural fraud detection methods of manual check deposits. Because mobile/remote check deposits rely on data passed between computing devices over network communications utilizing various types of computing devices, these conventional systems introduced additional opportunities for fraud.

As suggested by the foregoing, embodiments of the visual deposit system 106 provide a variety of technical advantages relative to conventional systems. For example, by extracting check image features from a check image and utilizing the check image features to identify fraud indicators, the visual deposit system 106 improves accuracy relative to conventional systems. Specifically, in some implementations, the visual deposit system 106 utilizes a vision-language model to extract check image features such as check information features and physical features of the check image. Indeed, by utilizing the vision-language model, the visual deposit system 106 extracts check information features (e.g., from text on the check) more accurately than OCR methods and extracts physical features that OCR methods cannot extract. Based on these extracted check image features, the visual deposit system 106 can identify a significantly higher percentage of fraudulent deposit requests in comparison with conventional systems. Similarly, in some embodiments, the visual deposit system 106 utilizes the check information features and physical features of the check image to more accurately identify fraudulent deposit requests by training and implementing a mobile check deposit model or utilizing a vision-language model to leverage extracted image features.

Additionally, in one or more embodiments, by utilizing different types of data for detecting fraudulent check deposit requests, the visual deposit system 106 improves operational flexibility relative to conventional systems. In particular, the visual deposit system 106 utilizes different types of data such as check information features, physical features of a check image, and/or historical transaction information to detect fraud. For example, to detect fraud, the visual deposit system 106 utilizes check information features such as transaction information, payee information, payer information, etc., from the check image directly rather than relying merely on user input information via a client application (e.g., a deposit amount of the check). Moreover, in one or more implementations, the visual deposit system 106 also utilizes physical features of the check image to detect fraud. Indeed, by utilizing multi-modal models to extract image features from a check image, the visual deposit system 106 can utilize the check information features and/or the physical features of the check image in combination with historical transaction information.

Further, by extracting and/or utilizing check information features to detect fraudulent check deposit requests, the visual deposit system 106 provides a technological solution to the technological problems created by conventional methods of verifying the authenticity of data passed during mobile check deposit processes. Specifically, the visual deposit system 106 provides a technological solution by utilizing a vision-language model to extract check information features and/or physical features of a check image to verify the authenticity of transaction data including the check image. Further, the visual deposit system 106 provides a technological solution by utilizing the check information features and/or physical features with a deposit decision model to automatically identify and reject fraudulent deposit requests. In some embodiments, the visual deposit system 106 provides the technological solution by training and implementing a mobile check deposit model to identify and utilize the check information features and/or physical features from the check image for fraud detection. Additionally, the visual deposit system 106 can provide the technological solution by utilizing a vision-language model to identify and utilize the check information features and/or physical features from the check image for fraud detection.

As mentioned above, in some embodiments, the visual deposit system 106 generates a machine learning model prompt including a check image of a deposit request (e.g., a mobile check deposit request). Indeed, in some implementations, the visual deposit system 106 generates the machine learning model prompt in response to receiving the deposit request and for use with a machine learning model (e.g., a vision-language model). FIG. 2 illustrates a diagram of the visual deposit system 106 generating a machine learning model prompt in accordance with one or more embodiments.

As shown in FIG. 2, in one or more embodiments, the visual deposit system 106 receives a check image 204 from a client device 202 (e.g., a mobile phone or other computing device such as client device 102). In particular, the visual deposit system 106 receives the check image 204 as part of a deposit request for depositing funds indicated on a check in the check image 204 into a client banking account. In one or more implementations, the check image 204 can refer to a digital image/s of the front of the check and/or the back of the check.

As further illustrated in FIG. 2, in some embodiments, the visual deposit system 106 generates a machine learning model prompt 206 in response to the deposit request. Specifically, the visual deposit system 106 generates the machine learning model prompt 206 to include the check image 204. Moreover, in some implementations, the visual deposit system 106 generates the machine learning model prompt 206 to include instructions 208 for extracting features of the check image (or check image features).

In one or more embodiments, the visual deposit system 106 generates the instructions 208 to include with, or within, the machine learning model prompt 206. In particular, the instructions 208 include detailed directives to guide the behavior and output of a machine learning model (e.g., the vision-language model 108 of FIG. 1). The instructions 208 can be formulated as explicit commands, open-ended guidance, constraints, formatting rules, or step-by-step procedures to shape responses. For example, the instructions can specify the type of and/or specific check image features to extract, contextual information for what the extracted features will be used, extraction rules for particular fields of the check, etc. In one or more implementations, the visual deposit system 106 generates the instructions 208 to include specific output requirements (e.g., data formats) and output examples for shaping the output.

In some embodiments, the visual deposit system 106 generates the instructions 208 to include detailed directives for extracting specific types of check image features. For example, the check image features can include different types of features such as check information features and check physical features (or physical features). Additional detail regarding specifics of the information features and physical features as well as the extraction thereof is provided with respect to FIGS. 3 and 4.

In some implementations, the visual deposit system 106 can perform pre-processing on the check image 204. For example, the visual deposit system 106 can rotate the check to the correct orientation (e.g., from vertical to horizontal or from upside down to correct side up). In another example, the visual deposit system 106 can convert the image to grayscale.

As noted above, in one or more embodiments, utilizes a vision-language model to extract check image features from a check image. For instance, the visual deposit system 106 utilizes the vision-language model to extract check information features from the check image. FIG. 3 illustrates a diagram of the visual deposit system 106 utilizing a vision-language model to extract check information features from a check image in accordance with one or more embodiments.

As portrayed in FIG. 3, in one or more implementations, the visual deposit system 106 provides a machine learning model prompt 302 (e.g., the machine learning model prompt 206 of FIG. 2) to a vision-language model 308 (e.g., the vision-language model 108 of FIG. 1). Specifically, the visual deposit system 106 utilizes the machine learning model prompt 302 with the vision-language model 308 to extract the check image features from the check image 304. For example, the visual deposit system 106 extracts the check image features as indicated in the instructions 306 (e.g., the instructions 208 of FIG. 2) of the machine learning model prompt 302 utilizing the vision-language model 308.

As also depicted in FIG. 3, in some embodiments, the visual deposit system 106 utilizes the vision-language model 308 to extract the check image features from information included on the check in the check image. In particular, the visual deposit system 106 can extract check information features 312 included on the check. For example, the visual deposit system 106 extracts the check information features 312 as illustrated in the boxes 310.

In some implementations, the check information features 312 include alphanumeric information regarding the transaction indicated by the check in the check image 304. Specifically, the visual deposit system 106 extracts check information features by identifying and extracting alphanumeric characters on the check. For example, the visual deposit system 106 identifies alphanumeric characters that are printed on the check or written on the check. Indeed, the visual deposit system 106 can identify information in various fields of the check as well as handwritten information in fields of the check or on any location of the check.

In one or more embodiments, the visual deposit system 106 identifies check information features 312 from fields of the check such as payee information (e.g., payee name/s), check date, signature status (e.g., member signature on the back of the check), memo line, payer information, check number, magnetic ink character recognition (MICR) value, numeric and text check amounts, check status, check type, verification verbiage status, check validity status, etc. Additionally, the visual deposit system 106 can identify fields that are missing data and include an indication that the data is missing in the output of the vision-language model 308. In these or other embodiments, the visual deposit system 106 extracts the check information features 312 as the output of the vision-language model 308.

As further illustrated in FIG. 3, in one or more implementations, the visual deposit system 106 provides the check information features for further processing A. In particular, the visual deposit system 106 utilizes the check information features 312 with a deposit decision model (e.g., the deposit decision model 110 of FIG. 1) as further described with respect to FIG. 5.

As mentioned previously, in some embodiments, utilizes a vision-language model to extract check image features from a check image. For example, the visual deposit system 106 utilizes the vision-language model to extract physical features of the check image. FIG. 4 illustrates a diagram of the visual deposit system 106 utilizing a vision-language model to extract physical features of a check image in accordance with one or more embodiments.

As depicted in FIG. 4, in some implementations, the visual deposit system 106 provides a machine learning model prompt 402 (e.g., the machine learning model prompt 206 of FIG. 2) to a vision-language model 408 (e.g., the vision-language model 108 of FIG. 1). Specifically, the visual deposit system 106 utilizes the machine learning model prompt 402 with the vision-language model 408 to extract the check image features from the check image 404. For example, the visual deposit system 106 extracts the check image features as indicated in the instructions 406 (e.g., the instructions 208 of FIG. 2) of the machine learning model prompt 402 utilizing the vision-language model 408.

As additionally shown in FIG. 4, in one or more embodiments, the visual deposit system 106 utilizes the vision-language model 408 to extract the check image features from information included in the check image. In particular, the visual deposit system 106 can extract physical features 412 of the check image 404. For example, the visual deposit system 106 extracts the physical features 412 as illustrated in the boxes 410. In one or more implementations, the visual deposit system 106 extracts the physical features 412 as the output of the vision-language model 408.

In some embodiments, the physical features 412 include information regarding objects and backgrounds of the check image 404. Specifically, the visual deposit system 106 extracts information regarding the condition of the check as well as other any other physical information included in the check image 404. For example, the visual deposit system 106 can extract physical features 412 such as physical alterations to the check, background information of the check image 404, whether a watermark is present on the check, designs or patterns of the check design, stamps, thumbprints, and in some cases alphanumeric information such as the word “void.” In some implementations, the visual deposit system 106 extracts the background information such as whether the check image 404 includes additional objects as well as the type of objects or the specific objects included in the background.

As further illustrated in FIG. 4, in one or more embodiments, the visual deposit system 106 provides the check information features for further processing B. In particular, the visual deposit system 106 utilizes the physical features 412 with a deposit decision model (e.g., the deposit decision model 110 of FIG. 1) as further described with respect to FIG. 5.

As noted previously, in one or more implementations, the visual deposit system 106 utilizes a deposit decision model to determine a transaction decision indicating whether to automatically accept or reject a deposit request. Indeed, in some embodiments, the visual deposit system 106 utilizes the deposit decision model to determine the transaction decision based on the extracted check image features. FIG. 5 illustrates a diagram of the visual deposit system 106 utilizing a deposit decision model to determine a transaction decision based on check image features in accordance with one or more embodiments.

As illustrated in FIG. 5, in some implementations, the visual deposit system 106 utilizes a deposit decision model 502 to compare extracted check image features of the check image (e.g., check image 104) with fraud indicators in response to generating the fraud indicators utilizing the visual-language model of FIG. 4. Specifically, the deposit decision model 502 determines whether to automatically accept or reject a transaction (e.g., a deposit request), or to flag the transaction for manual review. For example, the deposit decision model 502 utilizes a set of check deposit rules 504 to classify the transaction as either accepted, rejected, or flagged for review. Thus, in one or more embodiments, the visual deposit system 106 includes a plurality of models in sequence (e.g., a vision-language model followed by a classification model) to determine and implement a transaction decision for a check deposit process.

In one or more embodiments, the check deposit rules 504 include a combination of heuristics, rules, and risk assessment criteria for determining whether to accept or reject a check. In particular, the check deposit rules 504 include rules based on client account history (e.g., check deposit history, account behavior, transaction history, etc.). Furthermore, in one or more implementations, the check deposit rules 504 include rules for comparing check image features with fraud indicators. Additionally, in some embodiments, the check deposit rules 504 include rules for utilizing the check image features as extracted by the vision-language model or post-processed check image features. In one or more embodiments, the check deposit rules 504 include heuristics determined by comparing the check image features to features determined by a mobile check deposit model that utilizes transaction data not in the check image for classifying a check deposit request.

In some implementations, the visual deposit system 106 post-processes the check image features extracted by the vision-language model. In these or other embodiments, the visual deposit system 106 performs the post-processing prior to utilizing the check image features with the deposit decision model 502. Specifically, the visual deposit system 106 can post process check image features to modify, reformat, or otherwise adjust the extracted check image features. For instance, the visual deposit system 106 can reformat extracted names (e.g., from “Doe, Robert” to “Robert Doe”) or determine a similarity between extracted information (e.g., “Bob” vs. “Robert”) to determine if the information matches, etc.

As also depicted in FIG. 5, in one or more embodiments, the visual deposit system 106 utilizes the deposit decision model 502 to compare the check information features 506 extracted via the vision-language model with various types of expected or known data according to the check deposit rules 504. In particular, the visual deposit system 106 compares the check information features 506 with the account information of the client account submitting the deposit request (e.g., the payee) and/or the account information of the payer account issuing the check.

In one or more implementations, the visual deposit system 106 performs this comparison to determine whether text-based fraud indicators 508 are present in the check image (or in the transaction represented by the check image). Specifically, the visual deposit system 106 compares the extracted check information to determine if text-based fraud indicators 508 such as a mismatch between the check information features 506 and the account information (e.g., of the payee or payer) are present.

To illustrate, the visual deposit system 106 compares the payee information with the client account information of the client account associated with the deposit request. In particular, the visual deposit system 106 compares the payee name with the name information of the client account to determine whether a payee mismatch fraud indicator is present. For example, the visual deposit system 106 determines a payee mismatch is present if the payee name in the check image does not match the payee information of the client account. To illustrate, if the visual deposit system 106 determines the payee name is “John Smith” and the client account requesting the check deposit is “Jane Doe,” the visual deposit system 106 determines that a payee mismatch fraud indicator is present.

In some embodiments, because the visual deposit system 106 utilizes the vision-language model to extract the payee information, the payee name extracted from the check image need not be an exact match for the visual deposit system 106 to determine that a payee mismatch is not present. To illustrate, the visual deposit system 106 utilizes the vision-language model to determine that the payee in the check image is “Bob Doe,” and includes optional payee names (e.g., Robert Doe) when providing the output. Alternatively, in some implementations, the visual deposit system 106 provides the name “Bob Doe” in the output and the visual deposit system 106 utilizes the deposit decision model 502 to determine that “Bob Doe” and the account holder “Robert Doe” are (e.g., based on a similarity measure). Additionally, the visual deposit system 106 accommodates other name variations (e.g., formatting variations such as “Robert Doe” vs. “Doe, Robert”) utilizing the deposit decision model 502.

In another example, the visual deposit system 106 compares the payee name with the payer name to determine if self-check fraud indicator is present. For instance, the visual deposit system 106 determines that a self-check fraud indicator is present when the payee name matches the payer name (e.g., both are John Smith). In one or more embodiments, the visual deposit system 106 can determine that a self-check fraud indicator is not present even though the payee name and payer name are close matches (e.g., John Smith paying John Smith II). For example, the visual deposit system 106 utilizes the vision-language model to extract such subtle differences and provide these differences in the output (e.g., the check information features 506 of FIG. 5).

To further illustrate, the visual deposit system 106 compares the signature status (e.g., the member signature on the back of the check) with the payee account information of the account requesting the deposit. For instance, the visual deposit system 106 compares the signature on the check image to a verified signature (e.g., of a signature card) of the payee account. For example, the visual deposit system 106 determines whether a signature mismatch is present.

In another example, the visual deposit system 106 compares the payer information with payer account information of the account issuing the check. Specifically, the visual deposit system 106 determines whether the check of the check image includes a payer name mismatch. For instance, the visual deposit system 106 determines whether the payer name of the check matches the payer name in the payer account information. Further, in these or other embodiments, the visual deposit system 106 ensures the payer is authorized to issue the check to determine if an authorization mismatch is present.

Moreover, in one or more implementations, the visual deposit system 106 compares the MICR value of the check with payer account information. In particular, the visual deposit system 106 compares the MICR value with payer account information such as the account number, routing number, etc. For example, the visual deposit system 106 determines whether a MICR value mismatch is present.

Furthermore, in some embodiments, the visual deposit system 106 compares the extracted check information (e.g., a check number) with payer account information. Specifically, the visual deposit system 106 compares the check number with payer account information such as a check status to determine whether a check status mismatch is present. For instance, the visual deposit system 106 determines whether the check is unauthorized (e.g., because it has been voided, reported lost or stolen, etc.).

Additionally, in some implementations, the visual deposit system 106 compares the check type with the payer account information. In particular, the visual deposit system 106 compares the check type with payer account information such as whether the account is a personal, business, or other type of account. To illustrate, the visual deposit system 106 determines there is a check type mismatch if the check is a cashier's check, but the payer account is a personal account.

As previously mentioned, the visual deposit system 106 compares the check information features 506 with various types of expected or known data according to the check deposit rules 504. In one or more embodiments, the visual deposit system 106 compares the check information features 506 with transaction information of the check to determine whether any text-based fraud indicators 508 are present. In one or more implementations, the transaction information includes information such as a check date, memo line information, a check number, a check amount, check verification verbiage, etc.

To illustrate, the visual deposit system 106 compares the check date with current date information to determine whether text-based fraud indicators 508 such as a stale-dated check indicator or a post-dated check indicator. For example, the visual deposit system 106 determines a stale-dated check indicator is present if the check is older than a threshold time period (e.g., 6 months). In some embodiments, the visual deposit system 106 determines a post-dated check indicator is present if the check date is later than the current date (e.g., the date of the deposit request).

In another example, the visual deposit system 106 compares the memo line with known suspicious memo lines to determine if a memo indicator is present. For instance, the visual deposit system 106 determines that a memo indicator of fraud is present if the memo line matches with a known suspicious memo line (e.g., “loan repayment,” etc.).

To further illustrate, the visual deposit system 106 compares the check number with other check numbers previously issued by the payer account to determine if a check number indicator of fraud is present. For example, the visual deposit system 106 determines that a check number indicator is present if the check number in the check image is a duplicate of a previously issued check form the payer account, if the check number is altered or fake, if the check number is outside a threshold range of previously issued check numbers (e.g., if the last issued check was #1050, the check number of the check is #713, and the threshold number is 50).

In another example, the visual deposit system 106 compares the check number with known starter check numbers to determine if a starter check fraud indicator is present. For instance, the visual deposit system 106 determines if the check number is below a threshold (e.g., #100) to identify the check as a starter check (if below the threshold). In these or other embodiments, the visual deposit system 106 determines a starter check fraud indicator is present if the check is a starter check.

In an additional example, the visual deposit system 106 compares the numeric check amount and the text check amount for discrepancies. For example, the visual deposit system 106 determines that a check amount indicator of fraud is present if there is a discrepancy between the numeric check amount and the text check amount.

To illustrate further, the visual deposit system 106 compares the verification verbiage status with other check information features 506 for discrepancies. For instance, the visual deposit system 106 compares verification verbiage (e.g., instructions or words on chick outlining requirements for verifying authenticity of the check) with other information such as the check amount or the check date to determine if a verification verbiage status indicator of fraud is present. In one example, if the verification verbiage includes “do not cash if over $1,000,” and the visual deposit system 106 determines that the check amount is over $1,000, the visual deposit system 106 determines that a verification verbiage status indicator is present. In another example, if the verification verbiage includes “Two forms of ID are required to deposit this check,” or “Mobile check deposit prohibited,” the visual deposit system 106 determines that the check is automatically rejected.

Furthermore, in another example, the visual deposit system 106 determines whether official check verbiage is present for determining if an official check verbiage status of fraud is present. Specifically, the visual deposit system 106 determines that an official check verbiage indicator of fraud is present in response to determining that the check image includes verbiage assuring check legitimacy. For example, such verbiage includes terms like “Official Check” or similar keywords that indicate an attempt to pass off fraudulent checks as valid checks. Thus, in such cases, the visual deposit system 106 can determine that the check is automatically rejected in response to detecting image features from the check image based on such an indicator.

In a further example, the visual deposit system 106 compares the check validity status with other check information features 506 and check status information in banking databases. For example, based on the check information feature 506 such as the check number, the payer name, etc., the visual deposit system 106 determines that an invalid check indicator of fraud is present if the visual deposit system 106 determines that the check has been flagged as counterfeit, altered, or fraudulent in banking databases.

Additionally, or alternatively, as further illustrated in FIG. 5, the visual deposit system 106 utilizes the deposit decision model 502 to compare the physical features 510 extracted via the vision-language model with various sets of expected or known information. Specifically, the visual deposit system 106 determines whether the physical features 510 indicate physical fraud indicators 512.

To illustrate, the visual deposit system 106 utilizes the deposit decision model 502 to detect physical fraud indicators 512 in the background of the check image. In particular, the visual deposit system 106 determines whether the background includes an object in the check image in addition to a check in the check image or includes inconsistencies or other unusual elements. For instance, the visual deposit system 106 detects the presence of other documents, patterns, or surfaces in the background to determine whether a background indicator of fraud is present. In one example, the visual deposit system 106 determines that a background fraud indicator is present if the check image includes a cell-phone displaying the check.

Further, in some implementations, the visual deposit system 106 utilizes the deposit decision model 502 to detect a physical fraud indicator 512 including a predetermined check design pattern of a check design. Specifically, the visual deposit system 106 determines that a check design indicator of fraud is present if the check in the check image includes one or more check design patterns corresponding to a list of known check design patterns associated with fraudulent sources or that do not follow typical standard formatting of checks from legitimate sources. For example, the visual deposit system 106 can determine that a check includes specific patterns (e.g., in the corners, or other check locations) that match check design patterns associated with fraudulent sources or that fail to follow standard formatting used by legitimate check sources.

Moreover, in one or more embodiments, the visual deposit system 106 utilizes the deposit decision model 502 to detect a physical fraud indicator 512 including a physical alteration to the check in the check image. In particular, the visual deposit system 106 determines that an alteration indicator of fraud is present if the visual deposit system 106 detects signs of physical alterations on the check in the check image such as scratches, tape, whitener, etc., that is used to modify check details. For instance, the visual deposit system 106 determines an alteration indicator is present if the check in the check image appears to have rewritten or reprinted portions of the check.

Furthermore, in one or more implementations, the visual deposit system 106 utilizes the deposit decision model 502 to detect a physical fraud indicator 512 including a prior deposit indicator of fraud. For example, the visual deposit system 106 determines a prior deposit indicator is present if the visual deposit system 106 detects a stamp, a thumbprint, a keyword(s) (e.g., “void”) or other indication that the check was already deposited at a different financial institution.

Additionally, in some embodiments, the visual deposit system 106 utilizes the deposit decision model 502 to detect a physical fraud indicator 512 including a fraudulent check source indicator. Specifically, the visual deposit system 106 detects a fraudulent check source indicator such as the absence of a valid watermark in the check image or the presence of an unknown or altered watermark. In another example, the visual deposit system 106 detects a fraudulent check source indicator is present by determining that the check was created from a fraudulent website (e.g., based on list of known indicators of the website).

As additionally shown in FIG. 5, in some implementations, the visual deposit system 106 utilizes the deposit decision model 502 to determine a transaction decision 514. In particular, the visual deposit system 106 determines the transaction decision 514 to automatically accept or automatically reject the deposit request. For example, the visual deposit system 106 determines the transaction decision 514 according to the extracted check image features.

To illustrate, the visual deposit system 106 utilizes the deposit decision model 502 to determine the transaction decision 514 in response to determining that a text-based fraud indicator 508 and/or physical fraud indicator 512 is present or not present. Specifically, the visual deposit system 106 determines the transaction decision 514 based on the text-based fraud indicators 508 and/or physical fraud indicators 512. For example, the check deposit rules 504 can include different weights for different fraud indicators resulting in the visual deposit system 106 determining the transaction decision 514 based on one or more thresholds.

To further illustrate, the visual deposit system 106 determines that if the rejection threshold is reached or exceeded, the transaction decision 514 is a rejection of the check deposit (e.g., the visual deposit system 106 automatically rejects the check deposit). In one example, a single text-based fraud indicator 508 or physical fraud indicator 512, if present, has a weight sufficient to reach or exceed the fraud threshold. In another example, an accumulation of text-based fraud indicators 508 and/or physical fraud indicators 512 has a weight sufficient to reach or exceed the rejection threshold.

To illustrate further, the visual deposit system 106 generates a transaction decision 514 accepting (e.g., automatically) a check deposit if the weights of the detected text-based fraud indicators 508 and/or physical fraud indicators 512 do not reach or exceed an acceptance threshold. Further, in one or more embodiments, the visual deposit system 106 can determine that neither an automatic acceptance nor an automatic rejection is merited (e.g., the acceptance threshold is reached or exceeded but the rejection threshold is not reached or exceeded). If the visual deposit system 106 cannot make an automatic decision (e.g., either accepting or rejecting the check deposit request) the visual deposit system 106 flags the check image (and associated deposit request) for manual review C as discussed further below with respect to FIG. 6.

As further illustrated in FIG. 5, in one or more implementations, the visual deposit system 106 causes a transaction system 516 to accept or reject the deposit request. In some embodiments, the transaction system 516 includes one or more payment networks and/or one or more core banking platforms. In particular, a payment network of the transaction system 516 enables the electronic transfer of funds between a financial institution, clients, and/or merchants by facilitating secure transactions. Moreover, the core banking platform stores or accesses client account information, manages funds of a client account (e.g., by depositing or transferring the funds), etc.

Specifically, the visual deposit system 106 utilizes the transaction decision 514 to automatically cause the transaction system 516 to accept or reject the deposit request. Furthermore, in some implementations, the visual deposit system 106 provides a notification of the decision to a client device 518 either directly or via the transaction system 516. For instance, as illustrated in FIG. 5, the visual deposit system 106 provides a rejection notification to a client device 518.

As previously noted, in one or more embodiments, the visual deposit system 106 provides extracted check image features to a user device for manual review. Indeed, in one or more implementations, the visual deposit system 106 provides the extracted check image features for manual review if the visual deposit system 106 cannot automatically accept or reject a deposit request. FIG. 6 illustrates a diagram of the visual deposit system 106 providing extracted check image features for manual review in accordance with one or more embodiments.

As shown in FIG. 6, in some embodiments, the visual deposit system 106 generates a graphical user interface 604 for display on a user device 602 (also referred to herein as a system user device). In particular, the visual deposit system 106 generates the graphical user interface 604 for providing the check image features for display on the user device 602. For example, if the visual deposit system 106 cannot determine an automatic transaction decision based on the extracted check image features, the visual deposit system 106 displays the extracted check image features for manual review.

As also depicted in FIG. 6, in some implementations, the visual deposit system 106 provides the check image features for display by providing the check information features and/or the physical features for display in the graphical user interface 604. Specifically, the visual deposit system 106 generates the graphical user interface 604 to include a check information feature pane 608 including the check information features. Additionally, in one or more embodiments, the visual deposit system 106 generate the graphical user interface 604 to include a physical feature pane 610 including the physical features.

In one or more implementations, the visual deposit system 106 provides the highest priority check information features and physical features for display. In particular, the visual deposit system 106 provides the check information features and/or physical features that require manual review for display without displaying the check information features and/or physical features that do not require manual review. In some embodiments, the visual deposit system 106 provides the check information and/or physical features that require manual review for display at the top of the check information feature pane and/or physical feature pane 610. In some implementations, the visual deposit system 106 provides the check information features and/or physical features that require manual review with a highlighted display (e.g., bolded, underlined, colored, etc.) in the check information feature pane 608 and/or the physical feature pane 610.

As further illustrated in FIG. 6, in one or more embodiments, the visual deposit system 106 generates a check image pane 606. Specifically, the visual deposit system 106 generates the check image pane 606 to display the check image from the deposit request for manual review with the check information features and the physical features. In one or more implementations, the visual deposit system 106 provides the check image in the check image pane 606 to emphasize the aspects of the check image needing manual review (e.g., by emphasizing with annotations and/or markings such as boxes or borders around the information for review, arrows or pointers, color adjustments such as with color coding, labels, blurring or dimming areas that do not need review, etc.).

As additionally shown in FIG. 6, in some embodiments, the visual deposit system 106 provides a transaction decision pane 612. In particular, the visual deposit system 106 provides a transaction decision pane with interactive graphical elements (e.g., an accept element and/or a reject element). In some implementations, the visual deposit system 106 provides the transaction decision to a transaction system 614 (e.g., the transaction system 516 of FIG. 5) as described above with respect to FIG. 5. Further, in one or more embodiments, the visual deposit system 106 provides a notification of the transaction decision to a client device 618 (e.g., client device 202) submitting the deposit request as described above with respect to FIG. 5.

As mentioned above, in one or more implementations, the visual deposit system 106 trains a mobile check deposit model to determine a transaction decision indicating whether to accept or reject a deposit request. Indeed, in some embodiments, the visual deposit system 106 trains the mobile check deposit model to determine the transaction decision based on check image features of a check image. FIG. 7 illustrates a diagram of the visual deposit system 106 training a mobile check deposit model to determine a transaction decision based on check image features in accordance with one or more embodiments.

As portrayed in FIG. 7, in some implementations, the visual deposit system 106 the visual deposit system 106 trains a mobile check deposit model 708 based on a check image dataset. Specifically, the check image dataset includes digital images of checks. For example, the visual deposit system 106 utilizes a machine learning model prompt 702 including a check image 704 of the check image dataset and historical data 706 of a client account (e.g., mobile check deposit history, general account behavior, transaction history, etc.) with the mobile check deposit model 708 to generate a transaction decision 710.

In one or more embodiments, the mobile check deposit model 708 includes a machine learning model pre-trained to determine a transaction decision based on the historical data 706 of a client account associated with a deposit request. In particular, the mobile check deposit model 708 includes a binary classification model for determining whether to automatically accept, reject, or flag for manual review a transaction (e.g., a deposit request). For example, the deposit decision model 502 utilizes the historical data 706 with a set of check deposit rules.

As further illustrated in FIG. 7, in one or more implementations, the visual deposit system 106 utilizes the check image training dataset to train the mobile check deposit model 708 to determine a transaction decision 710 based on the check image 704 in addition to the historical data 706. Specifically, the visual deposit system 106 utilizes the prompt 702 including both the check image 704 and the historical data 706 with the mobile check deposit model 708 to generate the transaction decision 710. For example, the visual deposit system 106 utilizes the mobile check deposit model 708 to generate the transaction decision 710 indicating to automatically accept 712, automatically reject 714, or flag for manual review 716 the deposit request.

As also depicted in FIG. 7, in some embodiments, the visual deposit system 106 compares the transaction decision 710 to a ground truth decision 718. In some implementations, the ground truth decision 718 includes a correct decision based on check image features and historical data 706. For example, the ground truth decision 718 is based on check image features similar to the check image features described above with respect to FIGS. 3 and 4. In these or other embodiments, the check image features include the check information features and the physical features of the check as described above.

As further illustrated in FIG. 7, in one or more embodiments, the visual deposit system 106 updates the parameters of the mobile check deposit model 708. In particular, the visual deposit system 106 determines a loss 720 based on the comparison of the transaction decision 710 with the ground truth decision 718. Based on the loss 720, the visual deposit system 106 updates the parameters of the mobile check deposit model 708. In these or other embodiments, the visual deposit system 106 performs the training of the mobile check deposit model 708 for the digital images of checks in the check image database by iteratively updating the parameters of the mobile check deposit model 708 as just described.

As noted above, in one or more implementations, the visual deposit system 106 implements a mobile check deposit model to determine a transaction decision indicating whether to accept or reject a deposit request. Indeed, in some embodiments, the visual deposit system 106 implements the mobile check deposit model to determine the transaction decision based on check image features of a check image. FIG. 8 illustrates a diagram of the visual deposit system 106 implementing a mobile check deposit model to determine a transaction decision based on check image features in accordance with one or more embodiments.

As depicted in FIG. 8, in some implementations, the visual deposit system 106 the visual deposit system 106 generates a machine learning model prompt 802. Specifically, the visual deposit system 106 generates the machine learning model prompt 802 to include a check image 804 of a deposit request via a client device 822. Moreover, in one or more embodiments, the visual deposit system 106 generates the machine learning model prompt 802 to include historical data 806 of a client account (e.g., mobile check deposit history, general account behavior, transaction history, etc.) submitting the deposit request or other transaction data linked to the deposit request.

As additionally shown in FIG. 8, in one or more implementations, the visual deposit system 106 utilizes a mobile check deposit model 808 (e.g., the trained mobile check deposit model 708 of FIG. 7) with the machine learning model prompt 802 to generate a transaction decision 810. In particular, the visual deposit system 106 utilizes the mobile check deposit model 808 to determine the transaction decision 810 based on the check image features of the check image 804 and the historical data 806. For example, the visual deposit system 106 determines the transaction decision 810 based on the check information features and/or the physical features of the check image 804 as described above with respect to FIGS. 3 and 4.

To illustrate, the visual deposit system 106 utilizes the check image 304 with the mobile check deposit model 808 to determine the transaction decision 810 based on check information features such as from fields of the check including payee information (e.g., payee name/s), check date, signature status (e.g., member signature on the back of the check), memo line, payer information, check number, magnetic ink character recognition (MICR) value, numeric and text check amounts, check status, check type, verification verbiage status, check validity status, etc. For instance, the visual deposit system 106 utilizes the mobile check deposit model 808 to compare the check information features with account information (e.g., of the payee and/or payer) and/or transaction information of the check to determine whether any text-based fraud indicators are present as discussed above with respect to FIG. 5.

To further illustrate, visual deposit system 106 utilizes the check image with the mobile check deposit model 808 to determine the transaction decision 810 based on physical features of the check such check condition information, check image backgrounds and objects, etc. For example, the visual deposit system 106 utilizes the mobile check deposit model 808 to detect physical fraud indicators based on the physical features of the check image 804 as discussed above with respect to FIG. 5.

As further illustrated in FIG. 8, in some embodiments, the visual deposit system 106 determines the transaction decision 810 to automatically accept 812 or automatically reject 814 the deposit request. Furthermore, in some implementations, the visual deposit system 106 automatically causes a transaction system 818 (e.g., the transaction system 516 of FIG. 5) to accept or reject the deposit request based on the transaction decision 810 as discussed above with respect to FIG. 5.

In one or more embodiments, the visual deposit system 106 determines that the deposit request cannot be automatically accepted or rejected and flags the check image 804 of the deposit request for manual review 816. In these or other embodiments, the visual deposit system 106 provides the check image features (e.g., the check information features and/or the physical features) for manual review 820 as discussed above with respect to FIGS. 5 and 6. Additionally, in one or more implementations, the visual deposit system 106 provides a transaction decision from the manual review 820 to the transaction system to accept or reject the deposit request as also discussed above with respect to FIG. 6.

As also depicted in FIG. 8, in some embodiments, the visual deposit system 106 provides a notification of the decision to a client device 822 either directly or via the transaction system 818. For instance, the visual deposit system 106 provides an acceptance notification to the client device 822.

As mentioned previously, in some implementations, the visual deposit system 106 utilizes a vision-language model to determine a transaction decision indicating whether to accept or reject a deposit request. Indeed, in one or more embodiments, the visual deposit system 106 utilizes the vision-language model to act as a judge model for determining the transaction decision based on check image features of a check image. FIG. 9 illustrates a diagram of the visual deposit system 106 utilizing a vision-language model to determine a transaction decision based on check image features of a check image in accordance with one or more embodiments.

As illustrated in FIG. 9, in one or more implementations, the visual deposit system 106 generates a machine learning model prompt 902. Specifically, the visual deposit system 106 generates the machine learning model prompt 902 to include a check image 904 of a deposit request via a client device 916. Further, in some embodiments, the visual deposit system 106 generates the machine learning model prompt 902 to include instructions 906 for determining a transaction decision 912. In some implementations, the visual deposit system 106 generates the machine learning model prompt 902 to include historical data (e.g., the historical data 806 of FIG. 8) of a client account (e.g., mobile check deposit history, general account behavior, transaction history, etc.) submitting the deposit request.

In one or more embodiments, the instructions 906 for determining the transaction decision 912 include instructions for identifying check image features 910 of the check image 904. In particular, the instructions guide a vision-language model 908 (e.g., the vision-language model 308 of FIG. 3) in identifying check image features 910 such as check information features and physical features of the check image 904. For example, the visual deposit system 106 guides the vision-language model 908 to identify check information features and physical features similar to those discussed with respect to FIGS. 3 and 4.

In one or more implementations, the instructions 906 for determining the transaction decision 912 include guidance for identifying fraud indicators based on the check image features 910. Specifically, the instructions 906 guide the vision-language model 908 in determining whether any text-based fraud indicators or physical fraud indicators are present in the check image 904. For instance, the instructions 906 include guidance for determining whether the check information features indicate text-based fraud indicators or the physical features indicate physical fraud indicators.

Moreover, in some embodiments, the visual deposit system 106 utilizes historical data in combination with the check image features 910 to determine whether the check image 904 includes text-based fraud indicators and/or physical fraud indicators. In particular, the instruction 906 include guidance for the vision-language model 908 to determine the presence or absence of fraud indicators based on the historical data in combination with the check image features.

As further illustrated in FIG. 9, in some implementations, the visual deposit system 106 utilizes the vision-language model 908 to generate the transaction decision 912 indicating to automatically accept or reject the deposit request based on the presence and/or weights of fraud indicators as described above with respect to FIG. 5. Furthermore, in one or more embodiments, the visual deposit system 106 causes a transaction system (e.g., the transaction system 516 of FIG. 5) to accept or reject the deposit request based on the transaction decision 912 as discussed above.

As additionally shown in FIG. 9, in one or more implementations, the visual deposit system 106 provides a notification of the decision to the client device 916 either directly or via the transaction system 914. For example, the visual deposit system 106 provides a rejection notification to the client device 916.

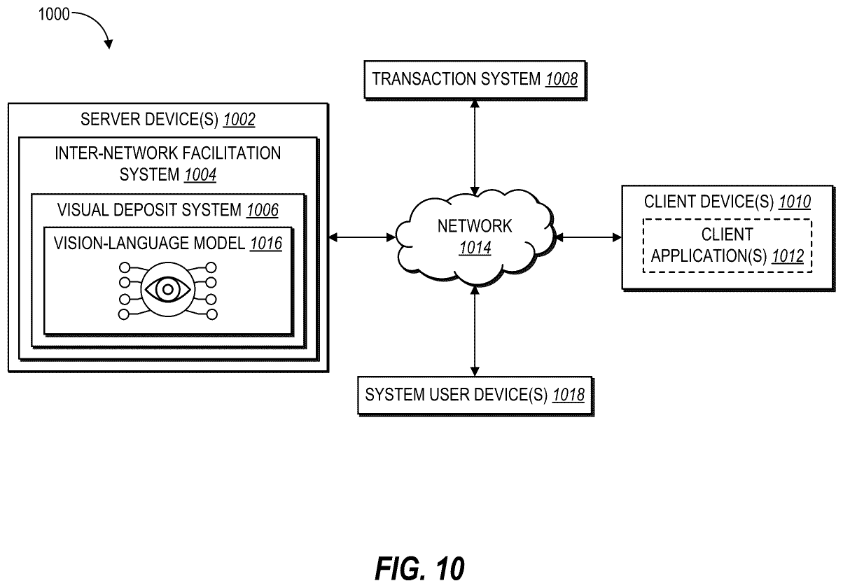

FIG. 10 illustrates a block diagram of a system environment 1000 for implementing an inter-network facilitation system 1004 and a visual deposit system 1006 (e.g., the visual deposit system 106 of FIG. 1) in accordance with one or more embodiments. As shown in FIG. 10, system environment 1000 includes server device(s) 1002 (which includes inter-network facilitation system 1004 and visual deposit system 1006), client device(s) 1010, transaction system 1008, and system user device(s) 1018. As further illustrated in FIG. 10, the server device(s) 1002, the client device(s) 1010, the transaction system 1008, and the system user device(s) 1018 can communicate via the network 1014.

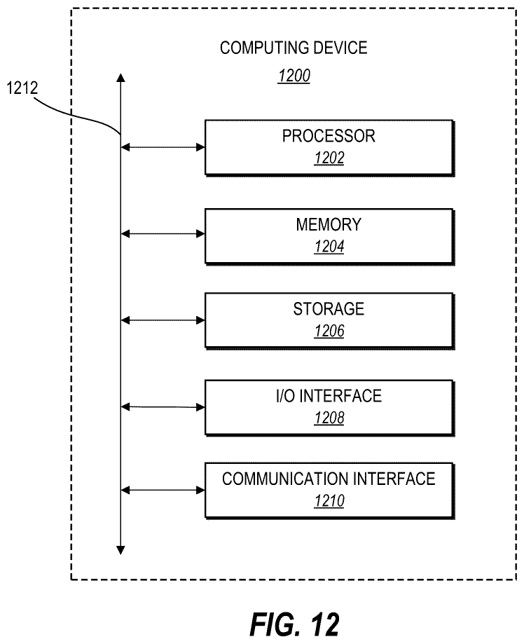

Although FIG. 10 illustrates the visual deposit system 1006 being implemented by a particular component and/or device within system environment 1000, the visual deposit system 1006 can be implemented, in whole or in part, by other computing devices and/or components within the system environment 1000 (e.g., the client device(s) 1010). Additional description regarding the illustrated computing devices (e.g., the server device(s) 1002, computing devices implementing the visual deposit system 1006, the client device(s) 1010, and/or the network 1014) is provided with respect to FIGS. 12 & 13 below.

As shown in FIG. 10, the server device(s) 1002 can include the inter-network facilitation system 1004. In some embodiments, the inter-network facilitation system 1004 can determine, store, generate, and/or display financial information corresponding to a user account (e.g., in a banking application or a money transfer application). Furthermore, the inter-network facilitation system 1004 can also electronically communicate (or facilitate) financial transactions between one or more user accounts (and/or computing devices). Moreover, the inter-network facilitation system 1004 can also track and/or monitor financial transactions and/or financial transaction behaviors of a user within a user account.

The inter-network facilitation system 1004 can include a system that comprises the visual deposit system 1006 and that facilitates financial transactions and digital communications across different computing systems over one or more networks. For example, the inter-network facilitation system 1004 manages credit accounts, secured accounts, and other accounts for one or more accounts registered within the inter-network facilitation system 1004. In some cases, the inter-network facilitation system 1004 is a centralized network system that facilitates access to online banking accounts, credit accounts, and other accounts within a central network location. Indeed, the inter-network facilitation system 1004 can link accounts from different network-based financial institutions to provide information regarding, and management tools for, the different accounts.

As illustrated in FIG. 1, the visual deposit system 1006 includes a vision-language model 1016 (e.g., the vision-language model 108 of FIG. 1) and/or a mobile check deposit model (e.g., the mobile check deposit model 708 of FIG. 7). Indeed, in these or other embodiments, the visual deposit system 1006 accesses the vision-language model 1016 (or the mobile check deposit model) to implement and/or modify parameters thereof to generate outputs such extracted check image features from a check image and/or a transaction decision indicating whether to accept or reject a deposit request. In some cases, the vision-language model 1016 (or the mobile check deposit model) are external to the visual deposit system 1006, but the visual deposit system 1006 nevertheless accesses and utilizes the vision-language model 1016 via one or more plugins, APIs, or other network-based access protocols.

Additionally, as shown in FIG. 10, system environment 1000 also includes the transaction system 1008. In some embodiments, transaction system interacts with the visual deposit system 1006 via the network 1014 to receive transaction decisions (e.g., the transaction decision 514 of FIG. 5). moreover, in some implementations, the transaction system 1008 interacts with a client application(s) 1012 of the client device(s) 1010 via the network 1014 to provide notifications of the transaction decisions to the client application(s) 1012.

As also illustrated in FIG. 10, system environment 1000 includes the client device(s) 1010. For example, the client device(s) 1010 may include, but are not limited to, mobile devices (e.g., smartphones, tablets) or other types of computing devices, including those explained below with reference to FIGS. 12 & 13. Additionally, the client device(s) 1010 can include computing devices associated with (and/or operated by) user accounts for the inter-network facilitation system 1004. Moreover, system environment 1000 can include various numbers of client devices that communicate and/or interact with the inter-network facilitation system 1004 and/or the visual deposit system 1006.

Furthermore, as shown in FIG. 10, the client device(s) 1010 can include client application(s) 1012. Client application(s) 1012 can include instructions that (upon execution) cause the client device(s) 1010 to perform various actions. For example, a user of a user account can interact with client application(s) 1012 on client device(s) 1010 to access financial information, initiate a financial transaction (e.g., transfer money to another account, deposit money, withdraw money), and/or access or provide data (to the server device(s) 1002). Furthermore, in one or more implementations, the client application(s) 1012 can display one or more graphical user interfaces from which the visual deposit system 1006 can receive and display information regarding network transactions.

In certain instances, the client device(s) 1010 corresponds to one or more user accounts (e.g., user accounts stored at the server device(s) 1002). For instance, a user of a client device can establish a user account with login credentials and various information corresponding to the user. In addition, the user accounts can include a variety of information regarding financial information and/or financial transaction information for users (e.g., name, telephone number, address, bank account number, credit amount, debt amount, financial asset amount), payment information (e.g., account numbers), transaction history information, and/or contacts for financial transactions. In some embodiments, a user account can be accessed via multiple devices (e.g., multiple client devices) when authorized and authenticated to access the user account within the multiple devices.

The present disclosure utilizes client devices to refer to devices associated with such user accounts. In referring to a client device, the disclosure and the claims are not limited to communications with a specific device but any device corresponding to a user account of a particular user. Accordingly, in using the term client device, this disclosure can refer to any computing device corresponding to a user account of the inter-network facilitation system 1004.

As illustrated in FIG. 10, system environment 1000 includes system user device(s) 1018. In one or more embodiments, the system user device(s) 1018 receive check image features from the visual deposit system 1006. Specifically, the system user device(s) receive and display the check image features corresponding check image of a deposit request. Additionally, the system user device(s) 1018 can receive an interaction via a graphical user interface indicating a transaction decision and provide the transaction decision and/or a notification of the decision to the visual deposit system 1006 and/or the transaction system 1008.

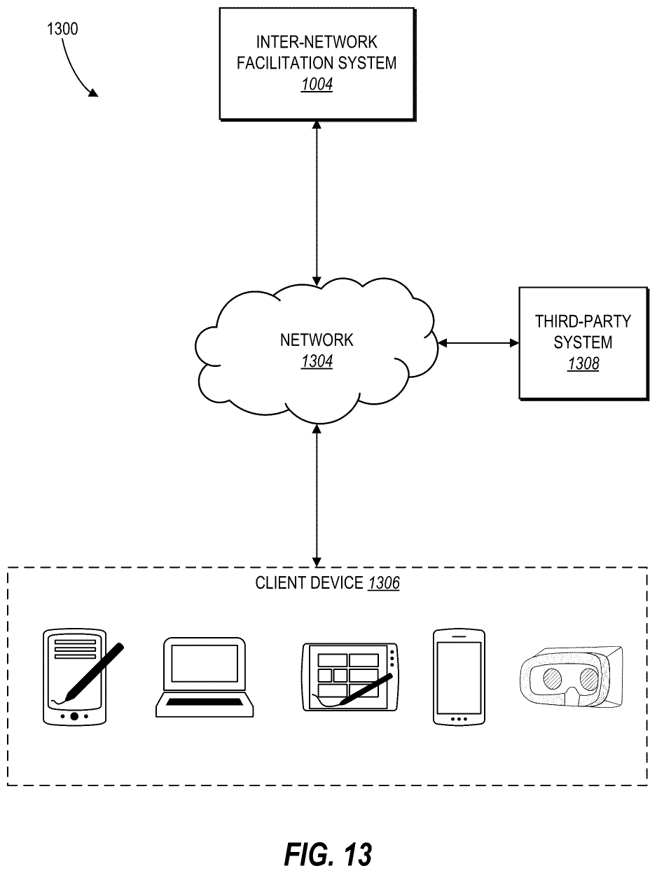

As further shown in FIG. 10, the system environment 1000 includes the network 1014. As mentioned above, the network 1014 can enable communication between components of the system environment 1000. In one or more embodiments, the network 1014 may include a suitable network and may communicate using a various number of communication platforms and technologies suitable for transmitting data and/or communication signals, examples of which are described with reference to FIG. 13. Furthermore, although FIG. 10 illustrates the server device(s) 1002, the client device(s) 1010, the transaction system 1008, and the system user device(s) 1018 communicating via the network 1014, the various components of the system environment 1000 can communicate and/or interact via other methods (e.g., the server device(s) 1002 and the client device(s) 1010 can communicate directly).

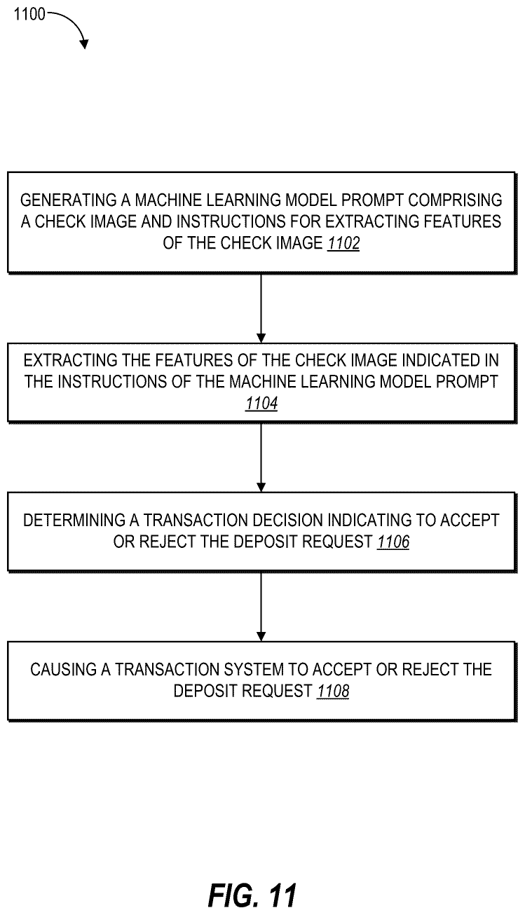

FIGS. 1-10, the corresponding text, and the examples provide a number of different systems, methods, and non-transitory computer readable media for utilizing a vision-language model to determine whether to accept or reject mobile checking deposits. In addition to the foregoing, embodiments can also be described in terms of flowcharts comprising acts for accomplishing a particular result. For example, FIG. 11 illustrates a flowchart of an example sequence of acts in accordance with one or more embodiments.

While FIG. 11 illustrates acts according to some embodiments, alternative embodiments may omit, add to, reorder, and/or modify any of the acts shown in FIG. 11. The acts of FIG. 11 can be performed as part of a method. Alternatively, a non-transitory computer readable medium can comprise instructions, that when executed by one or more processors, cause a computing device to perform the acts of FIG. 11. In still further embodiments, a system can perform the acts of FIG. 11. Additionally, the acts described herein may be repeated or performed in parallel with one another or in parallel with different instances of the same or other similar acts.

FIG. 11 illustrates an example series of acts 1100 for utilizing a vision-language model to extract check image features for determining whether to accept or reject a mobile check deposit request. The series of acts 1100 can include an act 1102 of generating a machine learning model prompt comprising a check image and instructions for extracting features of the check image; an act 1104 of extracting the features of the check image indicated in the instructions of the machine learning model prompt; an act 1106 of determining a transaction decision indicating to accept or reject the deposit request; and an act 1108 of causing a transaction system to accept or reject the deposit request.

In some embodiments, the act 1102 includes generating, by one or more servers in response to a deposit request including a check image from a client device, a machine learning model prompt including the check image and instructions for extracting features of the check image. In some embodiments, the act 1104 also includes an act of extracting, by the one or more servers utilizing a vision-language model, the features of the check image indicated in the instructions of the machine learning model prompt. In some implementations, the act 1106 further includes an act of determining, by the one or more servers utilizing a deposit decision model including a set of check deposit rules, a transaction decision indicating to accept or reject the deposit request according to the extracted features of the check image. Additionally, in one or more embodiments, the act 1108 includes an act of causing, by the one or more servers, a transaction system to accept or reject the deposit request based on the transaction decision.

In some implementations, extracting the features of the check image indicated in the instructions of the machine learning model prompt includes extracting, utilizing the vision-language model, check information features including alphanumeric information regarding a transaction indicated by a check in the check image. In one or more embodiments, determining the transaction decision indicating to accept or reject the deposit request according to the extracted features of the check image includes comparing the extracted check information features with account information of a client account submitting the deposit request to determine whether a text-based fraud indicator is present in the check image. In one or more implementations, the series of acts 1100 also includes an act of determining, utilizing the deposit decision model, the transaction decision to indicate to reject the deposit request in response to determining that the text-based fraud indicator is present.

In one or more implementations, determining, by the one or more servers utilizing the deposit decision model including the set of check deposit rules, the transaction decision indicating to accept or reject the deposit request according to the extracted features of the check image includes comparing the extracted check information features with transaction information of the check to determine whether a fraud indicator is present in the check image. In some embodiments, the series of acts 1100 further includes an act of determining, utilizing the deposit decision model, the transaction decision to indicate to reject the deposit request in response to determining that the fraud indicator is present.

In some embodiments, extracting the features of the check image indicated in the instructions of the machine learning model prompt includes extracting physical features of the check image. Additionally, in some implementations, the series of acts 1100 includes an act of determining the transaction decision indicating to accept or reject the deposit request according to the extracted features of the check image includes determining the transaction decision to accept or reject the deposit request in response to determining that the extracted physical features of the check image indicate one or more physical fraud indicators.

In some implementations, determining the transaction decision to accept or reject the deposit request in response to determining that the extracted physical features of the check image indicate the one or more physical fraud indicators includes detecting, utilizing the deposit decision model and based on the extracted physical features of the check image, the one or more physical fraud indicators including at least one of an object in addition to a check in the check image or a predetermined check design pattern. In one or more embodiments, the series of acts 1100 also includes an act of determining the transaction decision to indicate to reject the deposit request based on detecting a presence of the one or more physical fraud indicators.

In one or more embodiments, determining the transaction decision to accept or reject the deposit request in response to determining that the extracted physical features of the check image indicate the one or more physical fraud indicators includes detecting, utilizing the deposit decision model and based on the extracted physical features of the check image, the one or more physical fraud indicators including at least one of a physical alteration to a check in the check image, a prior deposit indicator, or a fraudulent check source indicator. In one or more implementations, the series of acts 1100 further includes an act of determining the transaction decision to indicate to reject the deposit request based on detecting a presence of the one or more physical fraud indicators.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 12 illustrates a block diagram of exemplary computing device 1200 (e.g., the server device(s) 1002 and/or the client device(s) 1010 of FIG. 10) that may be configured to perform one or more of the processes described above. One will appreciate that server device(s) 1002 and/or the client device(s) 1010 may comprise one or more computing devices such as computing device 1200. As shown by FIG. 12, computing device 1200 can comprise processor 1202, memory 1204, storage device 1206, I/O interface 1208, and communication interface 1210, which may be communicatively coupled by way of communication infrastructure 1212. While an exemplary computing device 1200 is shown in FIG. 12, the components illustrated in FIG. 12 are not intended to be limiting. Additional or alternative components may be used in other implementations. Furthermore, in certain implementations, computing device 1200 can include fewer components than those shown in FIG. 12. Components of computing device 1200 shown in FIG. 12 will now be described in additional detail.

In particular implementations, processor 1202 includes hardware for executing instructions, such as those making up a computer program. As an example and not by way of limitation, to execute instructions, processor 1202 may retrieve (or fetch) the instructions from an internal register, an internal cache, memory 1204, or storage device 1206 and decode and execute them. In particular implementations, processor 1202 may include one or more internal caches for data, instructions, or addresses. As an example and not by way of limitation, processor 1202 may include one or more instruction caches, one or more data caches, and one or more translation lookaside buffers (TLBs). Instructions in the instruction caches may be copies of instructions in memory 1204 or storage device 1206.

Memory 1204 may be used for storing data, metadata, and programs for execution by the processor(s). Memory 1204 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1204 may be internal or distributed memory.

Storage device 1206 includes storage for storing data or instructions. As an example and not by way of limitation, storage device 1206 can comprise a non-transitory storage medium described above. Storage device 1206 may include a hard disk drive (HDD), a floppy disk drive, flash memory, an optical disc, a magneto-optical disc, magnetic tape, or a Universal Serial Bus (USB) drive or a combination of two or more of these. Storage device 1206 may include removable or non-removable (or fixed) media, where appropriate. Storage device 1206 may be internal or external to computing device 1200. In particular implementations, storage device 1206 is non-volatile, solid-state memory. In other implementations, Storage device 1206 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1208 allows a user to provide input to, receive output from, and otherwise transfer data to and receive data from computing device 1200. I/O interface 1208 may include a mouse, a keypad or a keyboard, a touch screen, a camera, an optical scanner, network interface, modem, other known I/O devices or a combination of such I/O interfaces. I/O interface 1208 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1208 is configured to provide graphical data to a display for presentation to a user. The graphical data may be representative of one or more graphical user interfaces and/or any other graphical content as may serve a particular implementation.

Communication interface 1210 can include hardware, software, or both. In any event, communication interface 1210 can provide one or more interfaces for communication (such as, for example, packet-based communication) between computing device 1200 and one or more other computing devices or networks. As an example and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1210 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1210 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1210 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1212 may include hardware, software, or both that couples components of computing device 1200 to each other. As an example and not by way of limitation, communication infrastructure 1212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 13 illustrates an example network environment 1300 of the inter-network facilitation system 1004. The network environment 1300 includes a client device 1306 (e.g., client device(s) 1010), an inter-network facilitation system 1004, and a third-party system 1308 connected to each other by a network 1304. Although FIG. 13 illustrates a particular arrangement of the client device 1306, the inter-network facilitation system 1004, the third-party system 1308, and the network 1304, this disclosure contemplates any suitable arrangement of client device 1306, the inter-network facilitation system 1004, the third-party system 1308, and the network 1304. As an example, and not by way of limitation, two or more of client device 1306, the inter-network facilitation system 1004, and the third-party system 1308 communicate directly, bypassing network 1304. As another example, two or more of client device 1306, the inter-network facilitation system 1004, and the third-party system 1308 may be physically or logically co-located with each other in whole or in part.

Moreover, although FIG. 13 illustrates a particular number of client devices 1306, inter-network facilitation system 1004, third-party systems 1308, and networks 1304, this disclosure contemplates any suitable number of client devices 1306, FIG. 13, third-party systems 1308, and networks 1304. As an example, and not by way of limitation, network environment 1300 may include multiple client devices 1306, inter-network facilitation system 1004, third-party systems 1308, and/or networks 1304.

This disclosure contemplates any suitable network 1304. As an example, and not by way of limitation, one or more portions of network 1304 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1304 may include one or more networks 1304.

Links may connect client device 1306, inter-network facilitation system 1004 (e.g., which hosts the visual deposit system 106), and third-party system 1308 to network 1304 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1300. One or more first links may differ in one or more respects from one or more second links.

In particular embodiments, the client device 1306 may be an electronic device including hardware, software, or embedded logic components or a combination of two or more such components and capable of carrying out the appropriate functionalities implemented or supported by client device 1306. As an example, and not by way of limitation, a client device 1306 may include any of the computing devices discussed above in relation to FIG. 7. A client device 1306 may enable a network user at the client device 1306 to access network 1304. A client device 1306 may enable its user to communicate with other users at other client devices 1306.

In particular embodiments, the client device 1306 may include a requester application or a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device 1306 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1306 one or more Hyper Text Markup Language (“HTML”) files responsive to the HTTP request. The client device 1306 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 1004 may be a network-addressable computing system that can interface between two or more computing networks or servers associated with different entities such as financial institutions (e.g., banks, credit processing systems, ATM systems, or others). In particular, the inter-network facilitation system 1004 can send and receive network communications (e.g., via the network 1304) to link the third-party system 1308. For example, the inter-network facilitation system 1004 may receive authentication credentials from a user to link a third-party system 1308 such as an online bank account, credit account, debit account, or other financial account to a user account within the inter-network facilitation system 1004. The inter-network facilitation system 1004 can subsequently communicate with the third-party system 1308 to detect or identify balances, transactions, withdrawal, transfers, deposits, credits, debits, or other transaction types associated with the third-party system 1308. The inter-network facilitation system 1004 can further provide the aforementioned or other financial information associated with the third-party system 1308 for display via the client device 1306. In some cases, the inter-network facilitation system 1004 links more than one third-party system 1308, receiving account information for accounts associated with each respective third-party system 1308 and performing operations or transactions between the different systems via authorized network connections.

In particular embodiments, the inter-network facilitation system 1004 may interface between an online banking system and a credit processing system via the network 1304. For example, the inter-network facilitation system 1004 can provide access to a bank account of a third-party system 1308 and linked to a user account within the inter-network facilitation system 1004. Indeed, the inter-network facilitation system 1004 can facilitate access to, and transactions to and from, the bank account of the third-party system 1308 via a client application of the inter-network facilitation system 1004 on the client device 1306. The inter-network facilitation system 1004 can also communicate with a credit processing system, an ATM system, and/or other financial systems (e.g., via the network 1304) to authorize and process credit charges to a credit account, perform ATM transactions, perform transfers (or other transactions) across accounts of different third-party systems 1308, and to present corresponding information via the client device 1306.

In particular embodiments, the inter-network facilitation system 1004 includes a model for approving or denying transactions. For example, the inter-network facilitation system 1004 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 1004 and/or one or more third-party systems 1308), the inter-network facilitation system 1004 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 1004 may be accessed by the other components of network environment 1300 either directly or via network 1304. In particular embodiments, the inter-network facilitation system 1004 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by the server. In particular embodiments, the inter-network facilitation system 1004 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1306, or an inter-network facilitation system 1004 to manage, retrieve, modify, add, or delete, the information stored in a data store.

In particular embodiments, the inter-network facilitation system 1004 may provide users with the ability to take actions on various types of items or objects, supported by the inter-network facilitation system 1004. As an example, and not by way of limitation, the items and objects may include financial institution networks for banking, credit processing, or other transactions, to which users of the inter-network facilitation system 1004 may belong, computer-based applications that a user may use, transactions, interactions that a user may perform, or other suitable items or objects. A user may interact with anything that is capable of being represented in the inter-network facilitation system 1004 or by an external system of a third-party system, which is separate from inter-network facilitation system 1004 and coupled to the inter-network facilitation system 1004 via a network 1304.

In particular embodiments, the inter-network facilitation system 1004 may be capable of linking a variety of entities. As an example, and not by way of limitation, the inter-network facilitation system 1004 may enable users to interact with each other or other entities, or to allow users to interact with these entities through an application programming interfaces (“API”) or other communication channels.

In particular embodiments, the inter-network facilitation system 1004 may include a variety of servers, sub-systems, programs, modules, logs, and data stores. In particular embodiments, the inter-network facilitation system 1004 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 1004 may also include suitable components such as network interfaces, security mechanisms, load balancers, failover servers, management-and-network-operations consoles, other suitable components, or any suitable combination thereof. In particular embodiments, the inter-network facilitation system 1004 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 1004 and one or more client devices 1306. An action logger may be used to receive communications from a web server about a user's actions on or off the inter-network facilitation system 1004. In conjunction with the action log, a third-party-content-object log may be maintained of user exposures to third-party-content objects. A notification controller may provide information regarding content objects to a client device 1306. Information may be pushed to a client device 1306 as notifications, or information may be pulled from client device 1306 responsive to a request received from client device 1306. Authorization servers may be used to enforce one or more privacy settings of the users of the inter-network facilitation system 1004. A privacy setting of a user determines how particular information associated with a user can be shared. The authorization server may allow users to opt in to or opt out of having their actions logged by the inter-network facilitation system 1004 or shared with other systems, such as, for example, by setting appropriate privacy settings. Third-party-content-object stores may be used to store content objects received from third parties. Location stores may be used for storing location information received from client devices 1306 associated with users.

In addition, the third-party system 1308 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 1004 via the network 1304. A third-party system 1308 can communicate with the inter-network facilitation system 1004 to provide financial information pertaining to balances, transactions, and other information, whereupon the inter-network facilitation system 1004 can provide corresponding information for display via the client device 1306. In particular embodiments, a third-party system 1308 communicates with the inter-network facilitation system 1004 to update account balances, transaction histories, credit usage, and other internal information of the inter-network facilitation system 1004 and/or the third-party system 1308 based on user interaction with the inter-network facilitation system 1004 (e.g., via the client device 1306). Indeed, the inter-network facilitation system 1004 can synchronize information across one or more third-party systems 1308 to reflect accurate account information (e.g., balances, transactions, etc.) across one or more networked systems, including instances where a transaction (e.g., a transfer) from one third-party system 1308 affects another third-party system 1308.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
generating, by one or more servers in response to a deposit request comprising a check image from a client device, a machine learning model prompt comprising the check image and instructions for extracting features of the check image;
extracting, by the one or more servers utilizing a vision-language model, the features of the check image indicated in the instructions of the machine learning model prompt;
determining, by the one or more servers utilizing a deposit decision model comprising a set of check deposit rules, a transaction decision indicating to accept or reject the deposit request according to the extracted features of the check image; and
causing, by the one or more servers, a transaction system to accept or reject the deposit request based on the transaction decision.

2. The computer-implemented method of claim 1, wherein extracting the features of the check image indicated in the instructions of the machine learning model prompt comprises extracting, utilizing the vision-language model, check information features comprising alphanumeric information regarding a transaction indicated by a check in the check image.

3. The computer-implemented method of claim 2, wherein determining the transaction decision indicating to accept or reject the deposit request according to the extracted features of the check image comprises:
comparing the extracted check information features with account information of a client account submitting the deposit request to determine whether a text-based fraud indicator is present in the check image; and
determining, utilizing the deposit decision model, the transaction decision to indicate to reject the deposit request in response to determining that the text-based fraud indicator is present.

4. The computer-implemented method of claim 2, wherein determining, by the one or more servers utilizing the deposit decision model comprising the set of check deposit rules, the transaction decision indicating to accept or reject the deposit request according to the extracted features of the check image comprises:
comparing the extracted check information features with transaction information of the check to determine whether a fraud indicator is present in the check image; and
determining, utilizing the deposit decision model, the transaction decision to indicate to reject the deposit request in response to determining that the fraud indicator is present.

5. The computer-implemented method of claim 1, wherein:
extracting the features of the check image indicated in the instructions of the machine learning model prompt comprises extracting physical features of the check image; and
determining the transaction decision indicating to accept or reject the deposit request according to the extracted features of the check image comprises determining the transaction decision to accept or reject the deposit request in response to determining that the extracted physical features of the check image indicate one or more physical fraud indicators.

6. The computer-implemented method of claim 5, wherein determining the transaction decision to accept or reject the deposit request in response to determining that the extracted physical features of the check image indicate the one or more physical fraud indicators comprises:
detecting, utilizing the deposit decision model and based on the extracted physical features of the check image, the one or more physical fraud indicators comprising at least one of an object in addition to a check in the check image or a predetermined check design pattern; and
determining the transaction decision to indicate to reject the deposit request based on detecting a presence of the one or more physical fraud indicators.

7. The computer-implemented method of claim 5, wherein determining the transaction decision to accept or reject the deposit request in response to determining that the extracted physical features of the check image indicate the one or more physical fraud indicators comprises:
detecting, utilizing the deposit decision model and based on the extracted physical features of the check image, the one or more physical fraud indicators comprising at least one of a physical alteration to a check in the check image, a prior deposit indicator, or a fraudulent check source indicator; and
determining the transaction decision to indicate to reject the deposit request based on detecting a presence of the one or more physical fraud indicators.

8. A non-transitory computer-readable medium storing instructions that, when executed by at least one processing device, cause a computing device to:
generating, by one or more servers in response to a deposit request comprising a check image from a client device, a machine learning model prompt comprising the check image and instructions for extracting features of the check image;
extracting, by the one or more servers utilizing a vision-language model, the features of the check image indicated in the instructions of the machine learning model prompt;
determining, by the one or more servers utilizing a deposit decision model comprising a set of check deposit rules, a transaction decision indicating to accept or reject the deposit request according to the extracted features of the check image; and
causing, by the one or more servers, a transaction system to accept or reject the deposit request based on the transaction decision.

9. The non-transitory computer-readable medium of claim 8, wherein extracting the features of the check image indicated in the instructions of the machine learning model prompt comprises extracting, utilizing the vision-language model, check information features comprising alphanumeric information regarding a transaction indicated by a check in the check image.

10. The non-transitory computer-readable medium of claim 9, wherein determining the transaction decision indicating to accept or reject the deposit request according to the extracted features of the check image comprises:
comparing the extracted check information features with account information of a client account submitting the deposit request to determine whether a text-based fraud indicator is present in the check image; and
determining, utilizing the deposit decision model, the transaction decision to indicate to reject the deposit request in response to determining that the text-based fraud indicator is present.

11. The non-transitory computer-readable medium of claim 9, wherein determining, by the one or more servers utilizing the deposit decision model comprising the set of check deposit rules, the transaction decision indicating to accept or reject the deposit request according to the extracted features of the check image comprises:
comparing the extracted check information features with transaction information of the check to determine whether a fraud indicator is present in the check image; and
determining, utilizing the deposit decision model, the transaction decision to indicate to reject the deposit request in response to determining that the fraud indicator is present.

12. The non-transitory computer-readable medium of claim 8, wherein:
extracting the features of the check image indicated in the instructions of the machine learning model prompt comprises extracting physical features of the check image; and
determining the transaction decision indicating to accept or reject the deposit request according to the extracted features of the check image comprises determining the transaction decision to accept or reject the deposit request in response to determining that the extracted physical features of the check image indicate one or more physical fraud indicators.

13. The non-transitory computer-readable medium of claim 12, wherein determining the transaction decision to accept or reject the deposit request in response to determining that the extracted physical features of the check image indicate the one or more physical fraud indicators comprises:
detecting, utilizing the deposit decision model and based on the extracted physical features of the check image, the one or more physical fraud indicators comprising at least one of an object in addition to a check in the check image or a predetermined check design pattern; and
determining the transaction decision to indicate to reject the deposit request based on detecting a presence of the one or more physical fraud indicators.

14. The non-transitory computer-readable medium of claim 12, wherein determining the transaction decision to accept or reject the deposit request in response to determining that the extracted physical features of the check image indicate the one or more physical fraud indicators comprises:
detecting, utilizing the deposit decision model and based on the extracted physical features of the check image, the one or more physical fraud indicators comprising at least one of a physical alteration to a check in the check image, a prior deposit indicator, or a fraudulent check source indicator; and
determining the transaction decision to indicate to reject the deposit request based on
detecting a presence of the one or more physical fraud indicators.

15. A system comprising:
at least one processing device; and
at least one non-transitory computer-readable storage medium storing instructions that, when executed by the at least one processing device, cause the system to:
generating, by one or more servers in response to a deposit request comprising a check image from a client device, a machine learning model prompt comprising the check image and instructions for extracting features of the check image;
extracting, by the one or more servers utilizing a vision-language model, the features of the check image indicated in the instructions of the machine learning model prompt;
determining, by the one or more servers utilizing a deposit decision model comprising a set of check deposit rules, a transaction decision indicating to accept or reject the deposit request according to the extracted features of the check image; and
causing, by the one or more servers, a transaction system to accept or reject the deposit request based on the transaction decision.

16. The system of claim 15, wherein extracting the features of the check image indicated in the instructions of the machine learning model prompt comprises extracting, utilizing the vision-language model, check information features comprising alphanumeric information regarding a transaction indicated by a check in the check image.

17. The system of claim 16, wherein determining the transaction decision indicating to accept or reject the deposit request according to the extracted features of the check image comprises:
comparing the extracted check information features with account information of a client account submitting the deposit request to determine whether a text-based fraud indicator is present in the check image; and
determining, utilizing the deposit decision model, the transaction decision to indicate to reject the deposit request in response to determining that the text-based fraud indicator is present.

18. The system of claim 16, wherein determining, by the one or more servers utilizing the deposit decision model comprising the set of check deposit rules, the transaction decision indicating to accept or reject the deposit request according to the extracted features of the check image comprises:
comparing the extracted check information features with transaction information of the check to determine whether a fraud indicator is present in the check image; and
determining, utilizing the deposit decision model, the transaction decision to indicate to reject the deposit request in response to determining that the fraud indicator is present.

19. The system of claim 15, wherein:
extracting the features of the check image indicated in the instructions of the machine learning model prompt comprises extracting physical features of the check image; and
determining the transaction decision indicating to accept or reject the deposit request according to the extracted features of the check image comprises determining the transaction decision to accept or reject the deposit request in response to determining that the extracted physical features of the check image indicate one or more physical fraud indicators.

20. The system of claim 19, wherein determining the transaction decision to accept or reject the deposit request in response to determining that the extracted physical features of the check image indicate the one or more physical fraud indicators comprises:
detecting, utilizing the deposit decision model and based on the extracted physical features of the check image, the one or more physical fraud indicators comprising at least one of a physical alteration to a check in the check image, a prior deposit indicator, a fraudulent check source indicator, an object in addition to a check in the check image or a predetermined check design pattern; and
determining the transaction decision to indicate to reject the deposit request based on detecting a presence of the one or more physical fraud indicators.
